(19) United States
(12) Patent Application Publication
(10) Pub. No.: US 2007/0223460 A1
(43) Pub. Date: Sep. 27, 2007

(54) System and method for communicating VoIP module and telephone network

(76) Inventor: Scanner Chen, Xizhi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/389,192

(22) Filed: Mar. 27, 2006

(51) Int. Cl. H04L 12/66

(52) U.S. Cl. 370/356

(57) ABSTRACT

A communication system including a communication switch device for communicating a two-wired telephone device connected to a local computer with a local VoIP module and a remote computer with a remote VoIP module through an Internet network is disclosed. The communication switch device includes a two-wired speaker connection port connecting to the speaker output port of the computer through a first pairs of wires, a two-wired microphone connection port connecting to the microphone input port of the computer through a second pairs of wires. A VoIP module voice interface is connected to the local VoIP module of the computer through the two-wired speaker connection port and the two-wired microphone connection port through the first pairs of wires and the second pairs of wires respectively, so as to establish a communication between the two-wired telephone device and the local VoIP module of the computer by converting the audio signals carried on the first pairs of wires and the second pairs of wires to the two-wired telephone device.

### FIELD OF THE INVENTION

The present invention is in the general field of the communication switch system of Voice Over Internet Protocol, and more specifically in the field of the system and method for communicating the Voice Over Internet Protocol module and telephone network.

### BACKGROUND OF THE INVENTION

With the burgeoning of the World Wide Web and technologies related, ways of both living and working of citizens of the modem world has indeed changed to a certain degree. The convenience of the Broadband Internet makes it possible for enterprises, personal workshops, and even home users the fast and easy access to the Internet.

While the service of electronic mail has of all the services related to the Internet the highest proportion of use in earlier days, the capability of the Instant Message (IM) nowadays is much more complicated than communication via characters. Although IM is capable of data transferring, on-wire games, PC-to-PC communication via web cameras, and instant communication via voice, all of which ignore the limitation of regions, countries, and even continents, such useful fidelities are of many inconvenience and problems:

1. Since PC-to-PC communication is only operable in front of computers, users are required to stay in front of computers in order to proceed communications via the Internet, and that not only puts a limit on the space where users are allowed to stay in, but also misses the activeness, easiness and maneuverability which the ordinary PSTN (Public Switch Telephone Network) and cable telephone network possess;

2. Unlike the characteristic of multiple-user-at-the-same-time and multiple user communication that PSTN and cable telephone network has, PC-to-PC communication via voice (also known as VoIP, Voice Over Internet Protocol) is only operable to a limited number of users;

3. While utilizing VoIP a user is required to answer calls on the computer, and answering calls on any other handset, however, is not feasible;

4. A user of VoIP is required to operate on the keyboard and mouse of the computer, while operating on any device other than the computer is totally impossible, and that excludes the characteristic of convenience;

5. Since VoIP are only operable on the computers, desired communication via the Internet has a great chance to interrupt normal works on the computers; and

6. VoIP are only operable between computer users, so that they are incapable of communicating with PSTN and cable telephone network phones, hence VoIP cannot realize the goals of communicating between different communication systems.

### SUMMARY OF THE INVENTION

A primary object of the present invention, therefore, is to provide a communication system between VoIP and traditional telephone network and the method thereof by a controlling circuit in order to communicate the VoIP with traditional telephone network.

Another object of the present invention is to provide a controlling device and the method of same with an speaker input/output interface to link the VoIP and the telephone network in order to make communications between VoIP and telephone network phones possible.

A further object of the present invention is to provide a communication switch system that allows users to answer calls and operate VoIP by any telephone device other than the computer that connected to the system. Besides, VoIP modules provided with the system is capable of coupling, connecting, communicating, and net-meeting with devices outside of the computer such as in-door telephones, personal switching system, and cable telephone network.

To realize the above objects, the present invention installs a communication system including a communication switch device for communicating a two-wired telephone device connected to a local computer with a local VoIP module and a remote computer with a remote VoIP module through an Internet network is disclosed. The communication switch device includes a two-wired speaker connection port connecting to the speaker output port of the computer through a first pairs of wires, a two-wired microphone connection port connecting to the microphone input port of the computer through a second pairs of wires. A VoIP module voice interface is connected to the local VoIP module of the computer through the two-wired speaker connection port and the two-wired microphone connection port through the first pairs of wires and the second pairs of wires respectively, so as to establish a communication between the two-wired telephone device and the local VoIP module of the computer by converting the audio signals carried on the first pairs of wires and the second pairs of wires to the two-wired telephone device.

Further, the communication switch system could be in a form of a box electrically connected to the computer, in the preferred embodiment of the present invention, however, the communication switch system could be in the forms of integrated chips mounted on either sound-effect cards, mother board, or Internet adapter and modules built in either modems, computers, ordinary telephones, or wireless phones.

In comparison with the conventional technologies, the present invention entitles a PC-to-PC VoIP module with the system for communicating VoIP module to telephone network with the following:

1. The ability to answer calls and operate VoIP modules directly on a regular telephone and to communicate with any other communication devices of the entire network;

2. The ability of coupling, connecting, communicating, and net meeting with electronic devices outside of the computer such as in-door telephones, personal switching system, and cable telephone network without interrupting normal computer usage;

3. The ability to couple with, and transfer VoIP calls as well, to any communication devices automatically, so that answering calls by an ordinary telephone or any other device (such as cell phones) predetermined by the system is made possible; and

4. The exclusion of waiting calls in front of a computer, so that the computer is achieved to its maximum utility and free of use to any other member.

These and other aspects of the invention are described herein with reference to the accompanying Figures, which are representative of a few component designs which embody the principles and concepts of the invention, and which do not otherwise limit the scope of the invention as defined by the claims.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a computer connected to the telephone devices and the Public Switch Telephone Network by a communication switch device in accordance with the preferred embodiment of the present invention;

FIG. 2 is a block diagram showing the circuits in accordance with the preferred embodiment of the present invention;

FIG. 3 is a detailed diagram showing the circuits of the communication switch device of the present invention; and

FIG. 4 is a flowchart in accordance with the preferred embodiment of the present invention.

### DETAILED DESCRIPTION OF THE PREFERRED EMBODIMENTS

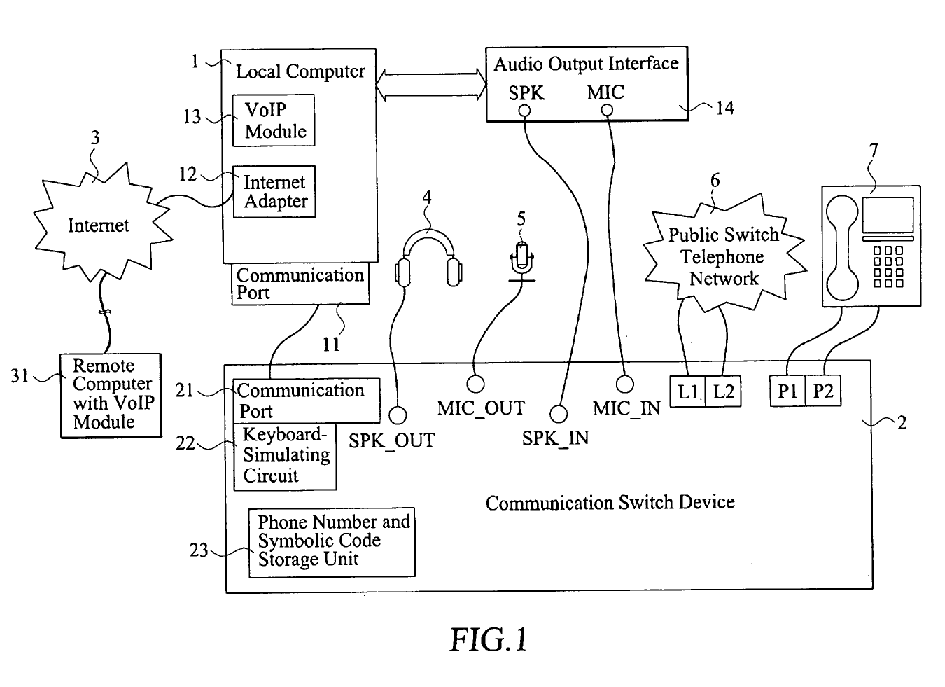

Please refer to FIG. 1 that shows a computer connected to the telephone devices and the Public Switch Telephone Network by a communication switch device in accordance with the preferred embodiment of the present invention. As shown in the figure, a local computer 1 connects to a communication switch device 2, and the communication switch device 2 is provided with a communication port 21 (a USB port for example) to electrically connect to a communication port 11 of the local computer 1.

The local computer 1 is connected to the Internet 3 through an Internet adapter 12 and is capable of executing a VoIP module 13 in order to communicate with an remote computer 31 with a VoIP module 31, wherein the VoIP module 13 could be an Instant Message program of conventional use or any other module of the same function. The communication switch device 2 further includes an speaker output, a microphone output, an speaker input, a microphone input, a pair of PSTN ports, and a pair of telephone ports, wherein the speaker output connects an speaker output device 4 (an earphone for instance), while the microphone output connects a microphone 5.

Further, the communication switch device 2 connects the audio port SPK and the microphone port MIC of an audio output interface 14 of the local computer 1, respectively, to the speaker input and the microphone input. Besides, the PSTN ports are used to connect the communication switch device 2 to the Public Switch Telephone Network 6, while the telephone ports are used to connect the communication switch device 2 to the telephone devices 7, so that the Public Switch Telephone Network 6, the telephone devices 7 and the VoIP module 13 are linked together forming a system with the capability to communicate with one another within the system.

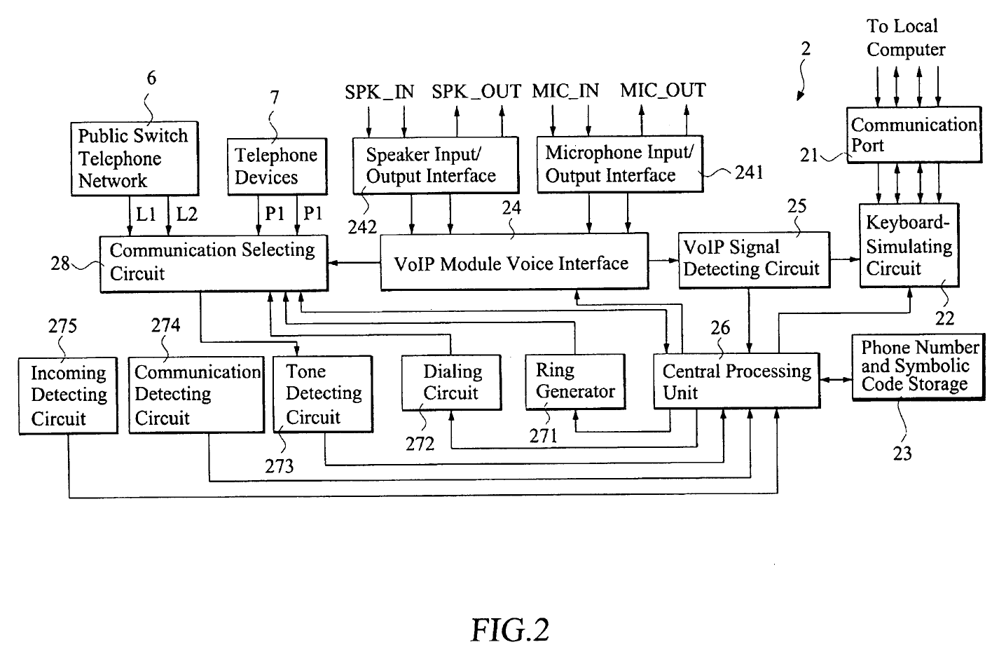

Please refer to FIG. 2, which is a block diagram showing the circuits in accordance with the preferred embodiment of the present invention. As shown in the figure, the communication switch device 2 is responsible of connecting the VoIP module 13 of the local computer 1, the Public Switch Telephone Network 6, and the telephone devices 7 are connected together forming a system able to communicate with one another.

As shown in the figure, the communication switch device 2 further includes a communication port 21, a keyboard-simulating circuit 22, a phone number and symbolic code storage unit 23, a VoIP module voice interface 24, a microphone input/output interface 241, a speaker input/output interface 242, a VoIP signal detecting circuit 25, a central processing unit 26, an ring generator 271, a dialing circuit 272, a tone detecting circuit 273, a communication status detecting circuit 274, an incoming detecting circuit 275, and a communication selecting circuit 28. In addition, a power supply 29 is used to supply the power the communication switch device 2 needs through the positive terminal S+, the ground terminal S−, and the working voltage Vcc.

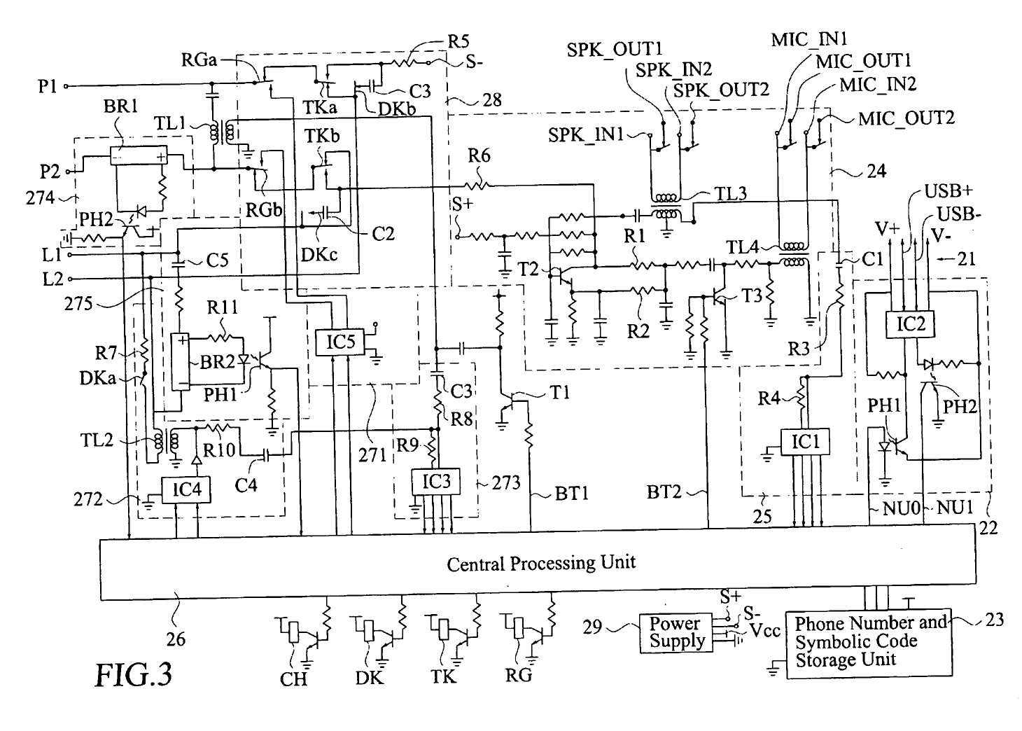

With reference to FIG. 3, a detailed diagram showing the circuits of the communication switch device in accordance with the preferred embodiment of the present invention, the detailed description of communication switch device 2 is as follows.

1. The VoIP module voice interface 24:

The main function of the VoIP module voice interface 24 is to transfer four-wire signals from the audio port SPK and the microphone port MIC from the local computer 1 to two-wire signals of the Public Switch Telephone Network 6, cable telephone network, or the telephone devices 7, and a transistor T2 is responsible for such function. The transistor T2 functions to transfer four-wire signals into two-wire signals, and vice versa. Four-wire signals from the audio port SPK of the local computer 1 are electrically connected to the base of the transistor T2 by a coupling unit TL3, and the emitter of the transistor T2 then transfers the signals into two-wire signals by a collector resistor R1 and a ground resistor R2. As a consequence, signals are sent to and received by the Public Switch Telephone Network 6 or the telephone devices 7 determined by the communication selecting circuit 28. On the contrary, electric currents are generated in the transistor T2 and then coupled to the microphone port MIC of the local computer 1 by the collector resistor R1 to a coupling unit TL4 through the collector of the transistor T2 when the communication selecting circuit 28 receives signals from the PSTN 6 or the telephone devices 7; the local computer 1 receives signals as a consequence.

Further, a transistor T3 controlled by the central processing unit 26 transmits tones that stand for “line busy”, “returning calls”, or “incoming calls” to the local computer 1, and the frequency of the tone is controlled by the central processing unit 26 as well.

2 The VoIP signal detecting circuit 25:

The VoIP signal detecting circuit 25 is composed of a tone decoder IC1, resistors R3, R4, and a capacitor C1, and the main function of the circuit 25 is to receive a predetermined tone representing the status of communication from the VoIP module 13 of the local computer 1. Such tones include incoming calls (for instance tone 88), ending calls (for instance tone 33), line busy (for instance tone 00), transferred calls from cable telephone network, and etc., and they are transferred to the central processing unit 26 after being coupled by the coupling unit TL3 and decoded by the tone decoder IC1.

The central processing unit 26 proceed corresponding procedures after receiving decoded tones from the tone decoder IC1, and such procedures include controlling telephone devices 7 generate rings through the ring generator 271 when the tone represents incoming calls, noticing the telephone devices 7 by sending tones representing ending calls through the transistor T1 driving by the output BT1, and noticing the telephone devices 7 by sending tones representing line busy through the transistor driving the output BT1 as well.

3. The keyboard-simulating circuit 22:

The main function of the circuit 22 is transfer signals and tones of the telephone devices to the keyboard commands used by the local computer 1, so that the VoIP module 13 of the local computer 1 is able to receive and process. The central processing unit 26 controls the keyboard-simulating circuit 22 send a ALT+PageUp command to the local computer 1 when incoming calls, a ALT+F command when activating the VoIP module 13 of the local computer 1, and a ALT+PageDown command to the local computer 1 when ending calls; such keyboard commands could be predetermined by the user.

The circuit 22 is composed of a corresponding command storage unit IC2, and is connected to the communication port 21 of the local computer 1 (while connecting to the keyboard directly is also feasible.) A signal line NU0 sends serial signals to a light-coupling element PH1 when the central processing unit 26 is to send keyboard commands to the local computer 1, and the serial signals are then transferred into corresponding keyboard commands by the corresponding command storage unit IC2. On the contrary, the local computer 1 is also able to send commanding signals to the corresponding command storage unit IC2 through the communications port 11 and 21 of the local computer 1 and the communication switch device 2 respectively, and such signals are sent to the central processing unit 26 by the signal line NU0 after being received by the corresponding command storage unit IC2 and coupled by the light-coupling element PH2.

4. The communication selecting circuit 28:

The circuit 28 mainly functions to (a) communicate the VoIP module 13 of the local computer 1 and the telephone device 7, (b) communicate the VoIP module 13 and the Public Switch Telephone Network 6, (c) communicate the telephone devices and the Public Switch Telephone Network 6, (d) enable multiple communication between the VoIP module 3, the telephone devices 7, and the PSTN 6, (e) transfer calls from the VoIP module 13 to other communication devices through the cable telephone network, (f) transfer calls from the cable telephone network to the VoIP module 13, and (g) stand by the communication switch device 2. The central processing unit 26 of the device 2 connects the above communication routes in accordance with the needs of the users by controlling the relays of the device 2.

The communication selecting circuit 28 is mainly composed of the relays CH, DK, TK, and RG. The PSTN ports L1 and L2 are electrically connected to the telephone ports P1 and P2 through the connectors TKa and TKb of the relay TK and the connectors RGa and RGb of the relay RG. The communication switch device 2 is free of use when it stands by.

Further, the communication between the VoIP module 13 of the local computer 1 and the telephone devices 7 is made possible by the following: the telephone port P1 is connected to the ground terminal S− through the normal close connector RGa of the relay RG, the normal open connector TKa of the relay TK, and a resistor R5, while the telephone port P2 is also connected to the collector of the transistor T2 through the rectifying circuit BR1, the normal open connectors RGb and TKb of the relays RG and TK, and a resistor R6. Consequently, the communication between the VoIP module 13 and the telephone devices 7 is connected.

The communication between the VoIP module 13 of the local computer 1 and the PSTN 6 is made possible by the following: the PSTN port L1 is electrically connected to the collector of the transistor T2 through the connector DKc of the relay DK, the capacitor C2, and the resistor R6, while the PSTN port L2 is connected to the ground terminal S− through the normal open connector DKb of the relay DK, the capacitor C3, and the resistor R5. Such connections communicate the VoIP module 13 and the PSTN 6. In addition, the PSTN port L1 is also connected to the PSTN port L2 through the resistor R28, the normal open connector DKa of the relay DK, and the coupling unit TL2; the goal of PSTN connection is completed by such connection.

Moreover, the communication between the telephone devices 7 and the PSTN 6 is made possible by the following: the telephone port P1 is connected to the PSTN port L2 through the normal close connector RGa of the relay RG and the normal close connector TKa of the relay TK, and the telephone port P2 is connected to the PSTN port L1 through the rectifying circuit BR1, the normal close connector RGb, and the normal close connector TKb.

The establish of the communication network of the VoIP module 13, the telephone devices 7 and the PSTN 6 is based on any two of the three terminals are connected, and the central processing unit 26 connects any terminal with one another when necessary. Assume that the telephone device 7 is already connected to the PSTN 6, which is the connection between the telephone port P1 and the PSTN port L2 through the connectors RGa and TKa and the connection between the telephone port P2 and the PSTN port L1 through the rectifying circuit BR1 and the connectors RGb and TKb, and the communication is being established, the central processing unit 26 connects the VoIP module 13 with the connection between the telephone devices and the PSTN when the VoIP module 13 is allowed to join the conversation. As a consequence, a three-way conversation is established and processed.

5. The tone detecting circuit 273:

The main function of the tone detecting circuit 273, which is composed of the coupling unit TL1, the capacitor C3, the resistor R8 and R9, and the tone detecting unit IC3, is to detect the communication route the telephone devices are to call and to decode the phone number of the calls. The circuit 273 transfers calls with head codes to the central processing unit 26; the central processing unit 26 then connects the calls to the desired VoIP module. On the contrary, the central processing unit 26 maintain the connection between the telephone devices 7 and the PSTN 6 when the circuit 273 detects that incoming calls are without a head code.

6. The dialing circuit 272:

The circuit 272, which is composed of the resistor R7, a relay DK, a coupling unit TL2, a resistor R33, a capacitor C14, and a dialing-processing unit IC4, mainly functions to receive commands from the central processing unit 26 in order to call out to the Public Switch Telephone Network 6.

7. The incoming detecting circuit 275:

The main function of the incoming detecting circuit 275 is to detect the calls from the cable telephone network, that is, a 20 Hz-ringing signal generated by the PSTN ports L1 and L2 is sent to the central processing unit 26 after being connected to the capacitor C5, the rectifying circuit BR2, and the resistor R11 and coupled by the light-coupling unit PH1. The central processing unit 26 detects the status of the incoming calls and activates the corresponding procedures.

8. The communication status detecting circuit 274:

The communication status detecting circuit 274 mainly functions to detect whether the telephone devices are busy or not. A direct current loop is connected when the telephone devices are busy, and the rectifying circuit BR1 is directly connected to the telephone port P2, and the central processing unit 26 detects the status of the telephone devices and activates the corresponding procedures.

9. The ring generator 271:

The main function of the ring generator 271, which is composed of relays RGa and RGb and an oscillator IC5, is to generate rings to the telephone devices 7 and then notify the telephone devices to answer calls in accordance with the commands sent by the central processing unit 26.

10. The central processing unit 26:

The central processing unit 26 is the controlling unit of the communication switch device 2, and it is responsible of communicating all communication devices with the aid of above circuits.

11. The phone number and symbolic code storage unit 23:

Since the telephone devices 7 merely generate numbers and the VoIP module 13 of the local computer 1 uses symbolic code, data of the symbolic code corresponding to the phone number stored in the phone number and symbolic code storage unit 23 are used to provide a corresponding relationship between the phone number and symbolic codes, and the central processing unit 26 is able to access the storage unit 23 when necessary. In addition, the storage unit 23 could be made into a plug-n-play type in the preferred embodiment.

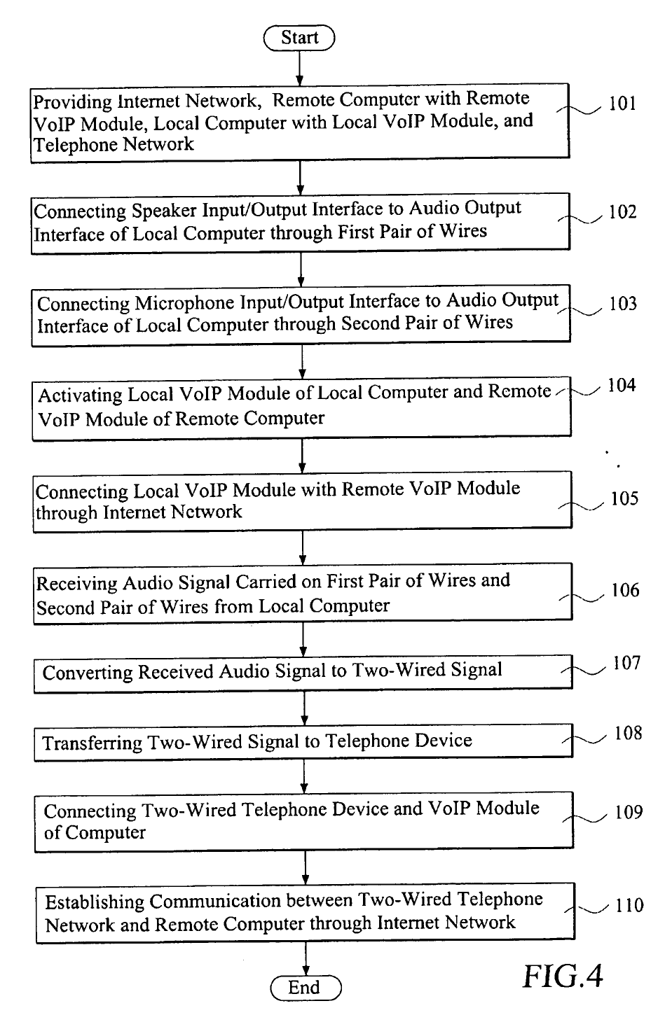

Please refer to FIG. 4, which is a flowchart in accordance with the preferred embodiment of the present invention. As shown in the figure, the method for communicating the VoIP Module 13 and the telephone network (telephone network or the PSTN 6) includes the following steps: first provides an Internet network 3, a remote computer 31 with a remote VoIP module, a local computer 1 with a local VoIP module 13, and a telephone device 7 (step 101). Further, connects the two-wired microphone input/output interface 241 to the audio output interface 14 of the local computer 1 through a first pairs of wires (step 102), then connects the two-wired speaker input/output interface 242 to the audio output interface 14 of the local computer 1 through a second pairs of wires (step 103).

After activating the VoIP module 13 of the local computer 1 and the remote VoIP module of the remote computer 31 (step 104), connects the local VoIP module 13 of the local computer 1 with the remote VoIP module of the remote computer 31 through the Internet network (step 105). The communication switch device 2 receives the audio signals carried on the first pairs of wires and the second pairs of wires (step 106). The communication switch device 2 then converts the received audio signal to the two-wired signal (step 107), and transfers the two-wired signal to the telephone network (step 108). Hence, connects the two-wired telephone network and the VoIP module 13 of the local computer 1(step 109), and establishes a communication between the two-wired telephone network and the remote computer 31 through the Internet network (step 110).

1. The connection between the VoIP module and the communication switch device:

The VoIP module 13 of the local computer 1 is provided with the speaker output SPK and the microphone input MIC of the audio output interface 14 in order to make communications possible. This type of connection, however, is not in accordance with the telephone devices or the PSTN, hence a direct connection between the VoIP module 13 and the PSTN is not possible in conventional use. The present invention, therefore, transfers the four-wire signals from the speaker output SPK and the microphone input MIC of the audio output interface 14 into the two-wire signals by the transferring and coupling of the VoIP module voice interface circuit 24, so that a direct communication between the VoIP module 13 and the PSTN 6 and the telephone devices 7 is made.

2. The connection when the VoIP module requests the communication switch device:

The VoIP module 13 of the local computer 1 sends tone signals with different tones from the audio output interface 14 when any communication device requests the module 13 with connection commands such as incoming calls, ending calls, transferring calls, and line busy. Further, the central processing unit 26 proceeds corresponding procedures after the tone signals are decoded.

3. The connection when the communication switch device requests the VoIP module of the computer:

The VoIP module 13 of the local computer 1 processes functions as the activating of the module 13, the answering of incoming VoIP calls, the ending of VoIP calls, the refusing of incoming calls, the sending of the numbers of the calls, and the activating of transferring calls when the communication switch device 2 requests the VoIP module 13. The communication switch device 2 sends commands to the VoIP module 13 of the local computer 1 through the keyboard-simulating circuit 22 and the communication port 21 of the communication switch device 2 and the communication port 11 of the local computer 1, and the VoIP module 13 of the local computer 1 processes the procedures corresponding to the commands.

4. The method when the communication switch device 2 requests the VoIP module transfer calls to contacts:

The contacts stored in the VoIP module 13 are codes composed of characters, symbols, and numbers instead of only numbers used in conventional telephones, so that calls generated by the telephone devices 7 and the PSTN 6 are not recognizable to the communication switch device 2. The present invention, therefore, stores codes corresponding to the numbers of the telephone network in the phone number and symbolic code storage unit 23, and the central processing unit 26 inquires the phone number and symbolic code storage unit 23 and transfers numbers to codes, so that the VoIP module 13 of the local computer 1 is able to recognize the numbers and to transfer calls to the desired contacts.

With the aid of the above protocols and connections and the transferring and the coupling of the signals, the central processing unit 26 is able to proceed procedures and accomplish goals of transferring calls between the VoIP module 13 of the local computer 1 and the PSTN 6 and the telephone devices 7, hence establishes the connection among the VoIP module 13, the telephone devices 7, and the PSTN 6.

The process of the communication switching:

1. The answering of incoming calls of the VoIP module:

The speaker output port of the local computer 1 is to receive tone signals from the VoIP module 13 of the local computer 1 when the VoIP module 13 is to call.

At the mean time, the tone signals are also transmitted and coupled to the VoIP module voice interface 24 and the transmitted to the central processing unit 26 after being decoded by the VoIP signal detecting circuit 25.

When the central processing unit 26 receives requests from the VoIP module 13, the central processing unit 26 first detects whether the telephone devices 7 are in use or not. The central processing unit 26 activates ring signals in order to make the telephone devices 7 generate rings if the telephone devices 7 are not in use, and the central processing unit 26 then sends commands to notify the VoIP module 13 of the local computer 1 through the keyboard-simulating circuit 22 and the communication ports 21. Further, the communication selecting circuit 28 is activated so that the connection of the VoIP module 13 and the telephone devices is established, and the microphone input MIC and the speaker input SPK of the local computer 1 are cut out to avoid interruptions.

On the contrary, the central processing unit 26 sends ending commands to the VoIP module 13 by activating the keyboard-simulating circuit 22 and the communication port 21 to notify the VoIP module 13 to end calls when the telephone devices 7 are in use or no one answers after a predetermined time interval (for example 15 ringing in this case.)

However, if the users have predetermined to transfer all incoming calls or no one answers after a predetermined time interval, the central processing unit 26 activates the communication selecting circuit 28 to transfer calls from the VoIP module 13 to the PSTN 6, and the microphone input MIC and the speaker input SPK of the local computer 1 are cut out to avoid interruptions.

2. The termination of the connection between the VoIP module and the telephone network:

At the time when the communication between the telephone devices 7 and the VoIP module 13 ends, the central processing unit 26 switches the receiver-selecting circuit 28 immediately to re-connect the telephone devices 7 and the PSTN 6, have the telephone devices 7 to recover the status of standing by, and reconnect the microphone input MIC and the speaker input SPK or the local computer 1.

If the VoIP module 13 sends the terminate-communication commands, however, the central processing unit 26 detects that the VoIP module 13 has sent the tone signals representing terminating calls by the VoIP signal detecting circuit 25, and at the mean time the central processing unit 26 also sends tone signals representing line busy to the telephone devices 7. The microphone input MIC and the speaker input SPK are reconnected as well.

3. The telephone devices request the VoIP module:

Users using telephone devices 7 calling the contacts in the VoIP module 13 of the local computer 1 are to dial a head code (a “#” or a “*” for example) ahead of the phone number or cell number of the contacts.

In accordance with the signals decoded by the tone detecting circuit 273 the central processing unit 26 switches call to the VoIP module 13 from the telephone devices 7 by the receiver-selecting circuit 28.

The central processing unit 26 receives the signals decoded by the tone-detecting circuit 273, and then read the corresponding codes that stand for the desired contact from the phone number and symbolic code storage unit 23.

The central processing unit 26 communicates with the VoIP module 13 by the keyboard-simulating circuit 22, sends commands that stand for activating the VoIP module 13, sends corresponding codes of the contacts to the VoIP module 13, and then sends controlling commands (for example an “ENTER”) to the module 13, so that the users of the module 13 is to answer calls.

After the central processing unit 26 is connected to the VoIP module 13 the microphone output MIC and the speaker output SPK are cut out so that no interruption can be made, hence the users of the telephone devices 7 are able to hold the calls and wait for the users of the VoIP module 13 to answer the calls.

The telephone devices 7 will receive tone signals representing line busy predetermined by the VoIP module 13 when the telephone devices 7 request the VoIP module 13 and the VoIP module 13 is busy.

The tone signals representing line busy are also transmitted and coupled to the VoIP module voice interface 24, and they are transmitted to the central processing unit 26 after being decoded by the VoIP signal detecting circuit 25 as well.

At the same time the central processing unit 26 also activates the keyboard-simulating circuit 22, communicates with the VoIP module 13 through the communication port 21, and send out commanding signals representing terminating calls to the VoIP module 13 to terminate connections. Last, the connection between the microphone input MIC and the speaker output SPK of the local computer 1 is being recovered.

4. The VoIP module makes calls through the communication switch device 2:

When calls from the VoIP module 13 are answered by the communication switch device 2 of the present invention, the VoIP module 13 sends out password and phone number of desired contact (for instance the password 1234 and the phone number 1800999888) to the central processing unit 26 after being coupled by the VoIP module voice interface 24 and decoded by the VoIP signal detecting circuit 25.

At the time when the central processing unit 26 receives the requests from the local computer 1, the central processing unit 26 controls the communication selecting circuit 28 switch connections to the VoIP module 13 from the telephone network.

The central processing unit 26 then activates the dialing line and sends the phone number 1800999888 to the PSTN 6, and connection is being established when the call is answered.

Last, both the VoIP signal detecting circuit 25 and the tone detecting circuit 273 receive tone signals representing terminating calls, and the central processing unit 26 will be notified to process the call-terminating procedures to recover the status of standing by between the telephone devices 7 and the telephone network.

5. The cable telephone network requests the VoIP module through the communication switch device:

When the communication switch device 2 detects incoming calls from the cable telephone network, the central processing unit 26 answers the calls after the tone detecting circuit 273 decoded the phone number of the calls, and activated the VoIP module 13 to proceed connection if calls from the cable telephone network are authorized. Besides, some calls can be entitled in advance with the authority to be transferred to the VoIP module 13 directly. In addition, call should be in the form of a head code and a phone number of the contact in order to be transferred to the VoIP module 13.

In accordance with the signals decoded by the tone detecting circuit 273 the central processing unit 26 switches call to the VoIP module 13 from the cable telephone network by the receiver-selecting circuit 28.

The central processing unit 26 receives the signals decoded by the tone-detecting circuit 273, and then read the corresponding codes that stand for the desired contact from the phone number and symbolic code storage unit 23.

The central processing unit 26 communicates with the VoIP module 13 by the keyboard-simulating circuit 22, sends commands that stand for activating the VoIP module 13, sends corresponding codes of the contacts to the VoIP module 13, and then sends controlling commands (for example an ENTER) to the module 13, so that the users of the module 13 is to answer calls.

After the central processing unit 26 is connected to the VoIP module 13 the microphone output MIC and the speaker output SPK of the local computer 1 are cut out so that no interruption can be made, hence the users of the cable telephone network are able to hold the calls and wait for the users of the VoIP module 13 to answer the calls on the telephone devices 7.

Last, both the VoIP signal detecting circuit 25 and the tone detecting circuit 273 receive tone signals representing terminating calls, and the central processing unit 26 will be notified to process the call-terminating procedures to recover the status of standing by between the telephone devices 7 and the telephone network.

6. Multi-user conversation:

When the connection between the telephone devices 7 and the PSTN 6 is established, the central processing unit 26 sends urging tones to both terminals in connection when the VoIP module 13 requests, so that both terminals in connection are to determine either to end their conversation or to allow the VoIP module 13 to join the conversation.

After the telephone devices 7 allow the VoIP module 13 to join the conversation and a button representing “conversation” is being pressed, the central processing unit 26 receives signals from the tone detecting circuit 273, and then switches the communication selecting circuit 28 back into connection. At the mean time, the central processing unit 26 also communicates with the VoIP module 13 of the local computer 1 through the communication port 21 by activating the keyboard-simulating circuit 22 and sends commands representing answering calls (for example the ALT+PageUp) to the VoIP module 13 to join in the conversation. Further, the connection of the microphone input MIC and the speaker output SPK are cut out to avoid interruption.

However, the central processing unit 26 terminates the connection of the PSTN 6 and maintains the connection between the telephone devices 7 and the VoIP module 13 when detecting the hanging up of the PSTN 6, while the central processing unit 26 terminates the connection of the telephone devices and maintains the connection between the PSTN 6 and the VoIP module 13 when detecting the hanging up of the telephone devices; the central processing unit 26, on the contrary, also terminates the connection of the VoIP module 13 and maintains the connection between the telephone devices 7 and the PSTN 6 by the communication selecting circuit 28 with a notification made by the VoIP signal detecting circuit 25.

Calls from the PSTN 6 can also be answered by the connection between the VoIP module 13 and the telephone devices 7, such process is made possible by the central processing unit 26 detecting the signals with the detectors of the telephone network and sending urging tones from the communication selecting circuit 28.

After the telephone devices 7 allow the VoIP module 13 to join the conversation and a button representing “conversation” is being pressed, the central processing unit 26 receives signals from the tone detecting circuit 273, and then switches the communication selecting circuit 28 back into connection. The procedures of terminating calls are the same with that stated above.

The telephone devices 7 are able to request to join the conversation between the VoIP module 13 and the PSTN 6, and the central processing unit 26 sends urging tones to both terminals in the conversation by the VoIP module voice interface 24 after the detecting of the detectors of the telephone devices. At the mean time, the users of the local computer 1 is to send commands that represents allowing the conversation, and the central processing unit 26 is to switch the communication selecting circuit 28 back into connection. Further, the procedures of terminating calls are the same with that stated above.

From above, the present invention integrates the output circuit of the communication devices and telephone network, and it is capable of coupling, connecting, communicating, and net meeting with electronic devices outside of the computer such as in-door telephones, personal switching system, and cable telephone network.

The present invention in reality use could be made in the forms of integrated chips mounted on either sound-effect cards, mother board, or Internet adapter and modules built directly in either modems, computers, ordinary telephones, or wireless phones in order to fulfill the needs of different users.

While the invention has been described in connection with what is presently considered to the most practical and preferred embodiments, it is to be understood that the invention is not to be limited to the disclosed embodiments, but on the contrary, is intended to cover various modifications and equivalent arrangement included within the spirit and scope of the appended claims.

What is claimed is:

1. A communication switch device for communicating a two-wired telephone device and a local VoIP module of a computer with a two-wired audio output port and a two-wired microphone input port, comprising:
a central processing unit;
a two-wired speaker connection port connecting to the audio output port of the computer through a first pairs of wires;
a two-wired microphone connection port connecting to the microphone input port of the computer through a second pairs of wires; and
a VoIP module voice interface connected to the local VoIP module of the computer through the two-wired speaker connection port and the two-wired microphone connection port through the first pairs of wires and the second pairs of wires respectively, to establish a communication between the two-wired telephone device and the local VoIP module of the computer by converting the audio signals carried on the first pairs of wires and the second pairs of wires to the two-wired telephone device.

2. The communication switch device as claimed in claim 1, further comprising a tone detecting circuit coupling to the central processing unit for detecting and decoding a tone signal from the telephone device.

3. The communication switch device as claimed in claim 1, further comprising a communication status detecting circuit connecting to the central processing unit for detecting the status of the telephone device.

4. The communication switch device as claimed in claim 1, further comprising a ring generator connecting to the central processing unit and the telephone device for generating a ringing signal to the telephone device.

5. The communication switch device as claimed in claim 1, further comprising a keyboard-simulating circuit connecting to the VoIP module of the computer and the central processing unit for converting signals and tones from the telephone device to the bit-based commands used by the computer so that the VoIP module of the computer is able to respond and proceed corresponding procedures.

6. The communication switch device as claimed in claim 1, further comprising a phone number and symbolic codes storage unit connecting to the central processing unit for providing a corresponding relationship between the numbers from the telephone device and symbolic codes from the VoIP module so that the communication switch device is able to transfer calls in between.

7. The communication switch device as claimed in claim 1, further comprising a VoIP signal detecting circuit connecting to the VoIP module of the computer and the central processing unit for receiving and converting a predetermined tone signal representing the status of the VoIP module thus enabling the central processing unit to proceed corresponding procedures after receiving a decoded tone signal from the VoIP signal detecting circuit.

8. The communication switch device as claimed in claim 1, further comprising a dialing circuit connecting to the telephone device and the central processing unit for receiving commands from the central processing unit in order to call out to the telephone device.

9. The communication switch device as claimed in claim 1, wherein the communication switch device is made in a form of integrated chips.

10. The communication switch device as claimed in claim 9, wherein the integrated chips is mounted on one of a sound-effect card, a motherboard, and an Internet adapter.

11. The communication switch device as claimed in claim 1, wherein the communication switch device is made in a form of built-in module built-in an electronic device.

12. The communication switch device as claimed in claim 11, wherein the electronic device is selected from a group including a modem, computer, ordinary telephone, and wireless phone.

13. The communication switch device as claimed in claim 1, wherein the communication switch device is made in a form of module box.

14. A communication switch system, comprising:
an Internet network;
at least one remote computer with a remote VoIP module connecting to the Internet network;
a computer with a local VoIP module, a two-wired audio output port, and a two-wired microphone input port, communicable with the remote VoIP of the remote computer through the Internet network;
a telephone network with at least a two-wired telephone device; and
a communication switch device connecting to the computer and the telephone network, comprising:
a central processing unit;
a two-wired speaker connection port connecting to the audio output port of the computer through a first pairs of wires;
a two-wired microphone connection port connecting to the microphone input port of the computer through a second pairs of wires; and
a VoIP module voice interface connected to the VoIP module of the computer through the two-wired speaker connection port and the two-wired microphone connection port through the first pairs of wires and the second pairs of wires respectively, to establish a communication between at least two of the two-wired telephone device of the telephone network, the VoIP module of the computer, and the VoIP module of the remote computer of the Internet network by converting the audio signals carried on the first pairs of wires and the second pairs of wires to the two-wired telephone device and vice versa.

15. The communication switch device as claimed in claim 14, wherein the telephone network is the cable telephone network.

16. The communication switch device as claimed in claim 14, wherein the telephone network is the Public Switch Telephone Network.

17. A method for communicating a two-wired telephone device connected to a local computer with a local VoIP module and a remote computer with a remote VoIP module through an Internet network, the local computer being provided with a two-wired audio output port and a two-wired microphone input port, comprising steps of:
(a) connecting the two-wired speaker connection port to the audio output port of the computer through a first pairs of wires;
(b) connecting the two-wired microphone connection port to the audio output port of the computer through a second pairs of wires;
(c) receiving the audio signal carried on the first pairs of wires and the second pairs of wires;
(d) converting the received audio signal to the two-wired signal;
(e) transferring the two-wired signal to the telephone device;
(f) Coupling the two-wired telephone device and the local VoIP module of the computer; and
(g) establishing a communication between the two-wired telephone device and the remote computer through the Internet network.
